(19) United States
(12) Patent Application Publication
(10) Pub. No.: US 2003/0199267 A1
(43) Pub. Date: Oct. 23, 2003

(54) Security system for information processing apparatus

(75) Inventors: Naoki Iwasa, Kawasaki (JP); Haruhisa Sakuma, Kawasaki (JP); Makoto Kawasaki, Kawasaki (JP); Yoshihisa Harada, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/440,103

(22) Filed: May 19, 2003

Related U.S. Application Data
(63) Continuation of application No. PCT/JP00/08256, filed on Nov. 22, 2000.

(51) Int. Cl. H04M 1/66

(52) U.S. Cl. 455/410; 455/411

(57) ABSTRACT

The invention comprises an information processing apparatus equipped with a first communication module having a wireless data communication capability, and a portable information apparatus equipped with a second communication module capable of forming a wireless communication link with the first communication module, and the information processing apparatus is configured so as to present a password entry screen only when the communication link is formed between the first and the second communication module. The first and second communication modules are Bluetooth-compatible communication modules. Unless the preregistered portable information apparatus is located near the information processing apparatus, and unless the correct password is entered, the information processing apparatus does not start up the OS. The invention can thus provide a security system, for an information processing apparatus, equipped with a double check mechanism.

### CROSS-REFERENCE TO RELATED APPLICATION

This application is a continuation application based upon PCT/JP00/08256 filed on Nov. 22, 2000.

### TECHNICAL FIELD OF THE INVENTION

The present invention relates to a strengthened security system for verifying the identity of an authorized user of an information processing apparatus such as a personal computer (hereinafter abbreviated as PC) and, more particularly, to a security system that can be easily constructed using a general-purpose apparatus without having to add special-purpose hardware or an application for activating the hardware.

### DESCRIPTION OF THE RELATED ART

With the rapidly shrinking size, increasing capacity, and decreasing price of hard disks, a tendency to store sensitive documents in electronic form in PCs has increased. Due to this tendency, secure management of PCs has become an important issue.

In a PC security system commonly used today, a password is set using a basic program called the BIOS (Basic Input Output System), and the OS is started only when the user has entered the correct password from the keyboard. That is, the identity of user of the PC is verified by the password preregistered in the BIOS.

However, there is a strong tendency to use personal details, such as birth dates, telephone numbers, or nicknames, as passwords, but such passwords can be relatively easily guessed by other persons. Once a password is known to a third party, the PC, if protected by the password, can be easily used by the third party.

In addition to password security, there are also proposed systems that attempt to further strengthen the security by using a fingerprint authentication device or by attaching an acceleration sensor to the PC with provisions made to shut down the system when movement of the PC is detected. Such systems, however, require the use of special hardware and the development of application software for the implementation thereof; furthermore, after the user has set the PC in an operating condition by clearing the security checks such as the password and the fingerprint authentication device, if the user leaves his desk, for example, the PC can be easily used by other persons.

To overcome this shortcoming, Japanese Unexamined Patent Publication No. H9-153016 entitled “PC USER IDENTIFICATION SYSTEM AND PC USER IDENTIFICATION METHOD”, for example, proposes a technique in which ID information identifying a person permitted to use a particular PC is prestored on a wireless IC card and the identity of the user carrying the IC card is verified by transferring the ID information to and from the PC via a wireless link.

The above-cited invention permits the use of the PC as long as the ID information is being transmitted to the PC. Therefore, when the user goes outside the card/PC wireless communication area, the PC automatically shuts down the system. This prevents unauthorized use of the PC by other persons when the user leaves his desk leaving the PC in an operating condition.

In this method and system, however, as special hardware such as a reader has to be installed near the PC in addition to using the wireless IC card, the system becomes complex, and besides, once the wireless IC card is stolen, there is no way to prevent unauthorized use.

A technique that enables a user to easily log in to a workstation by transmitting ID information via a wireless link using a portable telephone or an ID card, similarly to the technique disclosed in the above Patent Publication No. H9-153016, is proposed in Japanese Unexamined Patent Publication No. H8-307412 entitled “AUTOMATIC LOG-IN METHOD AND SYSTEM”. However, in this cited invention also, no consideration is given to security when the portable telephone, ID card, or the like is stolen, and therefore, no provisions are made against such cases.

### SUMMARY OF THE INVENTION

In view of the above deficiencies of the prior art security systems for information processing apparatuses, it is an object of the present invention to provide a security system for an information processing apparatus, that can strengthen security using a simple configuration and without requiring the use of special hardware or the development of special application software.

It is another object of the present invention to provide a security system, for an information processing apparatus, that can prevent unauthorized use by other persons by automatically activating the security system when the user leaves the information processing apparatus with the password entered therein.

To achieve the above objects, the invention provides a security system for an information processing apparatus, comprising: the information processing apparatus equipped with a first communication module having wireless data communication capability; and a portable information apparatus equipped with a second communication module capable of forming a wireless communication link with the first communication module, wherein the information processing apparatus is configured so as to present a password entry screen only when the communication link is formed between the first and the second communication module.

In this system, unless the portable information apparatus with preregistered authentication information is located near the information processing apparatus, and unless the preregistered password is entered by the user, the information processing apparatus does not start up the OS. A double security check mechanism can thus be easily constructed.

Further, the information processing apparatus is configured to start up the OS only when entry of the preregistered password is received from the portable information apparatus. This enables the information processing apparatus to be further closely associated with the particular portable information apparatus, and hence serves to strengthen the security.

The first and second communication modules are each constructed from a Bluetooth-compatible communication module. Accordingly, the system of the invention can be easily constructed by incorporating a Bluetooth-compatible communication module in the conventional information processing apparatus and portable information apparatus and without having to construct special hardware and application software for the security check. Further, in the case of Bluetooth devices, a piconet can be formed connecting between a plurality of devices; therefore, by assigning different passwords to a plurality of portable information apparatuses, the same information processing apparatus can be easily shared among a plurality of users while maintaining security among them.

Furthermore, the information processing apparatus is configured to place input devices in a locked state during startup of the OS, upon recognizing a disconnection of the communication link established between the first and second communication modules. Further, the information processing apparatus is configured so that when a resume button is operated, the password entry screen is presented only when the communication link is established between the first and second communication modules, and the input device lock state is unlocked when the preregistered password is entered.

With the above arrangement, even when the authorized user leaves his desk leaving the information processing apparatus in an operating condition without taking proper security measures, unauthorized use of the information processing apparatus by other persons can be prevented.

### BRIEF DESCRIPTION OF THE DRAWINGS

FIG. 1 is a block diagram showing a security system for an information processing apparatus according to one embodiment of the present invention;

FIG. 2 is a flowchart for explaining the operation of the security system shown in FIG. 1;

FIG. 3 is a diagram showing a security menu setup screen;

FIG. 4(a) is a diagram showing a user password setting screen;

FIG. 4(b) is a diagram showing a user password altering screen;

FIG. 5 is a flowchart for explaining the operation of the security system of FIG. 1 when the information processing apparatus is in use;

FIG. 6 is a flowchart for explaining the operation of the security system of FIG. 1 when restoring the information processing apparatus from sleep mode; and

FIG. 7 is a block diagram showing, in a simplified form, the configuration of the information processing apparatus shown in FIG. 1.

### DESCRIPTION OF THE PREFERRED EMBODIMENTS

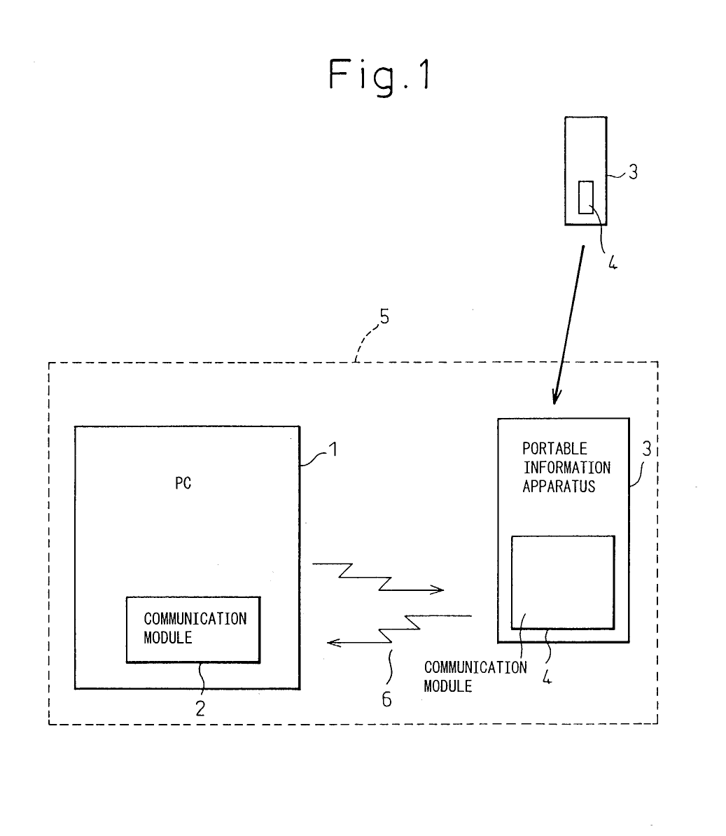

FIG. 1 shows a security system for an information processing apparatus according to one embodiment of the present invention, in which a PC is used as the information processing apparatus. The system comprises the PC 1, which incorporates a communication module 2 comprising an antenna and a special-purpose wireless communication device capable of data communication, and a portable information apparatus 3, which incorporates a similar communication module 4 comprising an antenna and a special-purpose wireless communication device. In this embodiment, the communication modules 2 and 4 are Bluetooth-compatible special-purpose chips, and the portable information apparatus 3 is a portable telephone or a PDA (Personal Digital Assistant).

The present invention will be described in detail below with reference to the embodiment in which the communication modules 2 and 4 are Bluetooth-compatible communication modules. The Bluetooth-compatible communication modules 2 and 4 each output a short signal, i.e., authentication information, to verify each other, and the apparatuses located within a short range can form a wireless link between them. The communication range is selectable between a range that covers the area of a room and a range that covers the area of a house.

The Bluetooth-compatible communication modules 2 and 4 verify each other by performing the following steps. First, 1) even when the PC 1 and the portable information apparatus 3 are in a power off condition, if the communication modules 2 and 4 are in a power on condition, the communication modules check if there is a Bluetooth-compatible apparatus nearby by transmitting low-power radio waves to each other at predetermined intervals of time. If the portable information apparatus 3 is outside the preset communication range 5 of the PC, no communication link is formed between the communication module 2 in the PC 1 and the communication module 4 in the portable information apparatus 3. In this case, the communication modules 2 and 4 remain in standby mode.

Next, 2) when the portable information apparatus 3 moves into the communication range 5, the communication module 2 in the PC 1 recognizes the presence of the Bluetooth-compatible module in its vicinity, and starts to acquire service. Then, 3) the PC 1 and the portable information apparatus 3 exchange identification information, and a piconet 6 is thus formed. At this time, the PC 1 is the master, and the portable information apparatus 3 is a slave. This state is the hold mode.

The communication link is formed between the PC 1 and the portable information apparatus 3, as described above. Since the above process is performed by the firmware incorporated in the Bluetooth communication modules, the process is carried out regardless of whether the PC and the portable information apparatus are in a power on or power off condition.

When the communication link is established between the communication module 2 in the PC 1 and the communication module 4 in the portable information apparatus 3, if power is already on to the PC 1, and if the Bluetooth wakeup setting in the BIOS is enabled, a wakeup request occurs from the Bluetooth communication module, and the PC 1 is automatically started up.

On the other hand, when the communication link is established, if power is off to the PC 1, and the Bluetooth wakeup setting in the BIOS is disabled, each communication module remains in the hold mode. In this case, the user must turn on the power switch to start the PC 1.

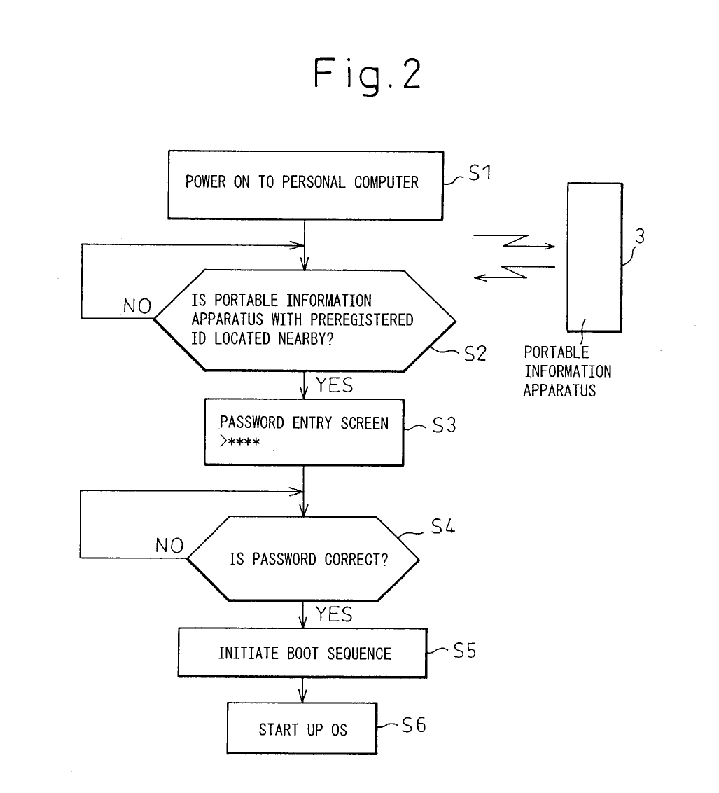

FIG. 2 is a flowchart illustrating the security check procedure in the BIOS when the user has turned on power to the PC 1. Security information in the BIOS is prestored in a security information area within a nonvolatile memory which stores the boot-up password, etc., and users are prohibited from altering this area.

First, when power is turned on to the PC 1 by the user (step S1), the BIOS, the basic program of the PC 1, is started and it checks to see whether the portable information apparatus having an recognition ID preregistered for security check is located nearby (step S2).

If the portable information apparatus 3 is outside the communication range of the communication module 2, no wireless link is formed to the communication module 4 in the portable information apparatus 3, as previously explained with reference to FIG. 1; in this case, since the decision in step S2 is NO, the BIOS does not proceed to the next step.

On the other hand, when the portable information apparatus 3 comes into communication range, that is, when the user carrying the portable information apparatus preregistered in the BIOS is located near the PC, a wireless link is formed and the identification information is exchanged between the communication modules; therefore, in this case, the decision in step S2 is YES.

In response to this decision, the BIOS causes the display screen to switch to the password entry screen, and waits for a password to be entered from the portable information apparatus 3 (step S3. At this time, the communication module 2 in the PC 1 and the communication module 4 in the portable information apparatus 3 transition to active mode, to enable data communications between the portable information apparatus and the PC.

The password to be entered here is the bootlock password, a string of numeric characters, supported by the BIOS.

When the user enters the password from the portable information apparatus 3 in accordance with the message on the password entry screen, the BIOS checks the password in step S4 to determine if it matches the preregistered one; if it matches the preregistered one (YES in step S4, the boot sequence is initiated (step S5, and the OS is started up (step S6. After the startup of the OS, the communication modules transition to low power mode, based on the Bluetooth applet in the OS. In this low power mode, the piconet connection is maintained.

On the other hand, if it is determined in step S4 that the entered password does not match the preregistered one, the BIOS returns to step S4, requests re-entry of the password, and checks once again if the entered password is correct or not. In this way, the BIOS does not start up the OS until the correct password is input.

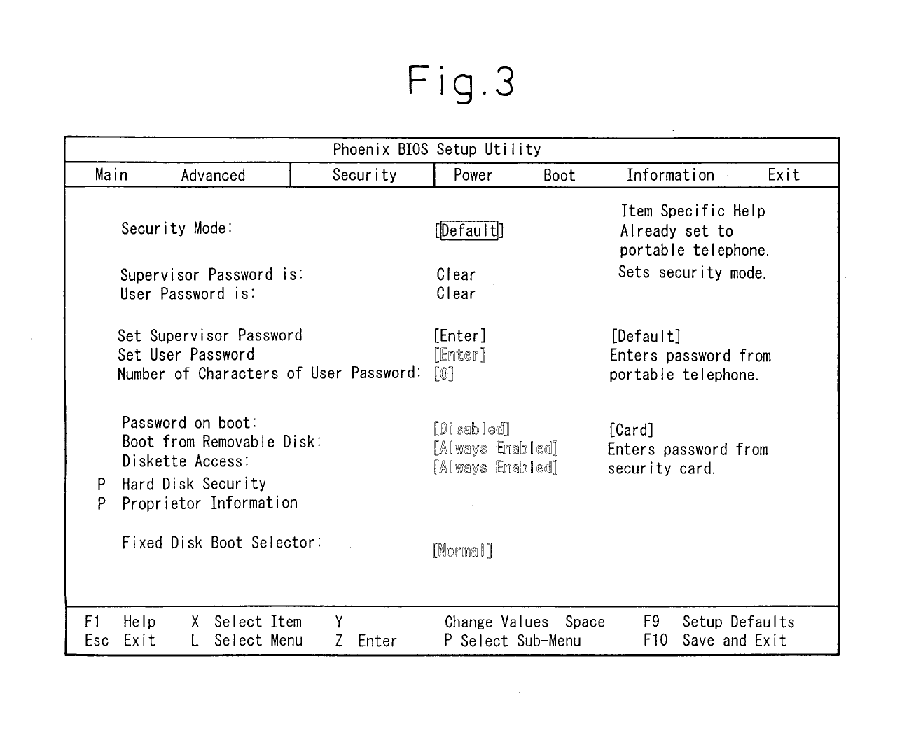

FIG. 3 shows one example of a BIOS setup security menu screen according to the present embodiment. In the illustrated example, a portable telephone is set for the security mode by default, indicating that the password must be set from the portable telephone.

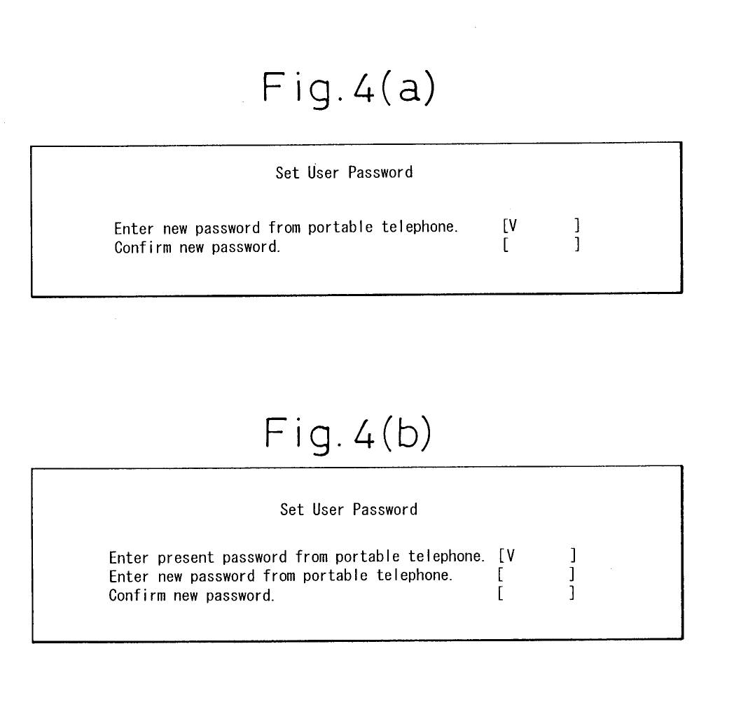

FIG. 4(a) shows a display screen which is presented when setting the user password for the first time, and FIG. 4(b) shows a display screen which is presented when altering the user password. In either case, the password is entered from the portable information apparatus in accordance with the message on the screen. If the PC is a network PC, a supervisor password can also be set; in this case also, by making provisions that the password be entered from the portable information apparatus, the security can be strengthened.

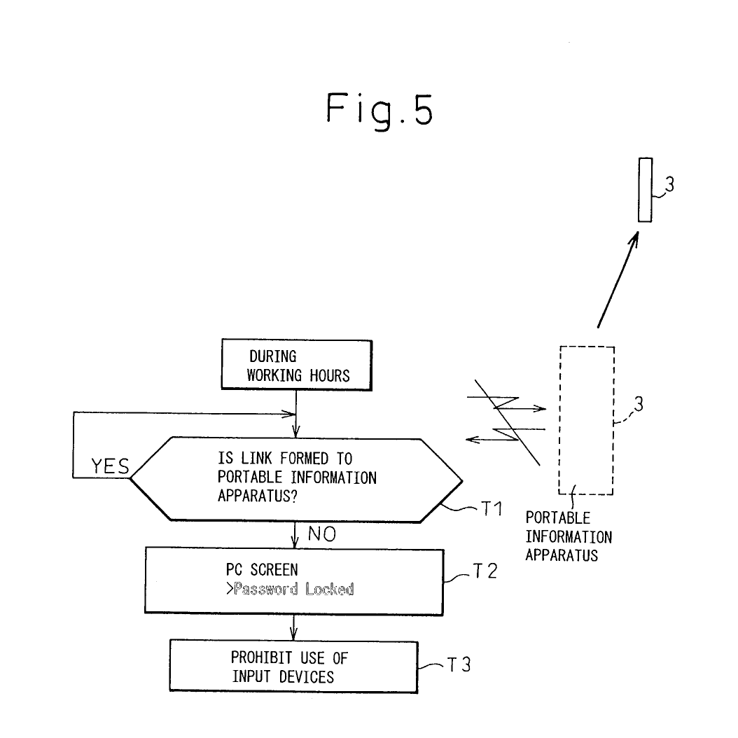

FIG. 5 is a flowchart illustrating the security check procedure in the BIOS during working hours. The BIOS periodically monitors the states of the communication modules 2 and 4 in the PC 1 and the portable information apparatus 3, to check whether the link is properly formed between them (step T1). Suppose here that the portable information apparatus 3 goes outside the communication range of the PC 1, for example, because the user leaves his desk by leaving the PC in an operating condition; then, as the communication link is disconnected, the communication modules 2 and 4 automatically enter the standby mode.

In this case, the decision in step T1 is NO, and the BIOS displays a password locked state on the display screen (or a status LCD) (step T2), locking the input devices such as the keyboard, mouse, etc. and thus prohibiting the use thereof (step T3) and, thereafter, it enters the power save mode.

In this way, even when the user leaves his desk without taking proper security measures, unauthorized use of the PC by anyone other than the authorized user can be prevented.

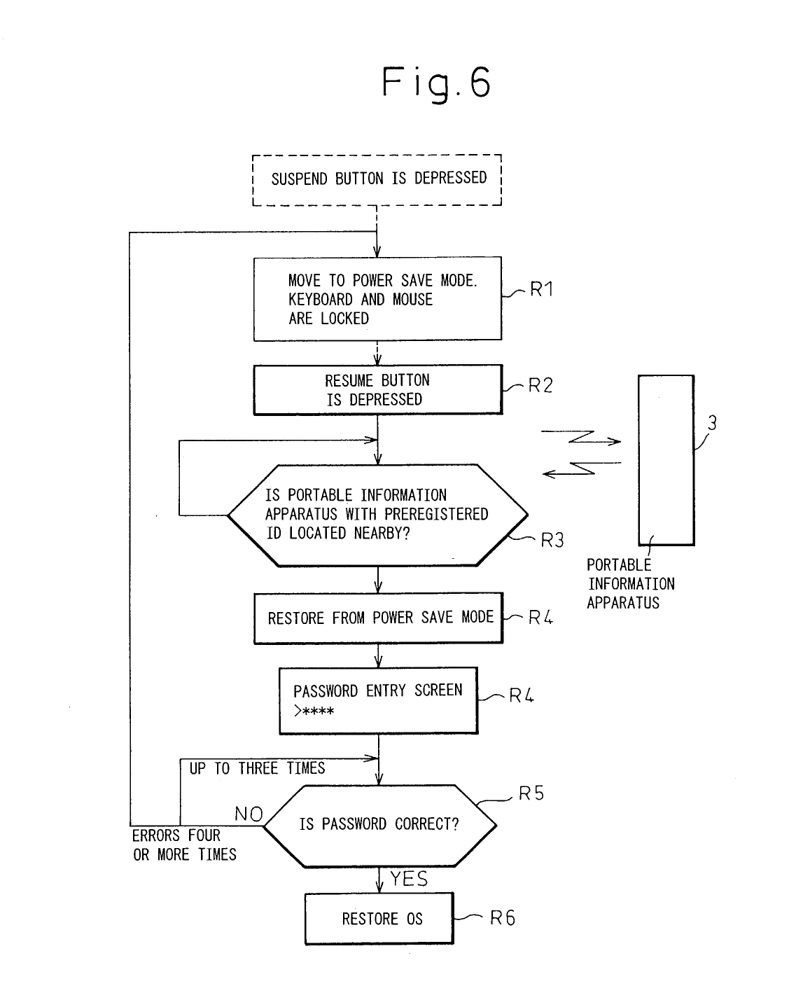

FIG. 6 is a flowchart illustrating the security check procedure in the BIOS when the user returns to his desk and resumes operation by depressing the resume button. This procedure is the same as the procedure for resuming operation after the user puts the PC in the power save mode by depressing the suspend button.

In step R1, the PC 1 is in the power save mode because the user is away from the desk or because the user depressed the suspend button; in this state, when the user returns to the desk and depresses the resume button (step R2), the BIOS checks whether the portable information apparatus 3 which has the preregistered ID is located nearby (step R3) and, if the portable information apparatus 3 is located nearby (YES in step R3), the BIOS restores the PC 1 from the power save mode (step R4) and displays the password entry screen on the display (step R5).

In this state, when the user enters the correct password from the portable information apparatus 3 (YES in step R5), the input device lock state is unlocked, and the OS is restored to the previous state (step R6). On the other hand, if it is determined in step R3 that the registered portable information apparatus is not located nearby (NO), the input device lock state is maintained, regardless of whether the resume button is depressed or not.

If the correct password is not entered in step R5, the process returns to the password entry screen to request re-entry of the password from the portable information apparatus. Here, to further enhance the security, provisions are made so that, if the user fails to enter the correct password three times, the process returns to step R1 to forcefully put the PC 1 into the power save mode.

In the configuration of the above embodiment, it is required that the password be entered from the portable information apparatus 3 in order to enhance security, but instead, provisions may be made to enter the password from the keyboard of the PC. Further, in the case of entering the password from the portable information apparatus 3, it may be configured so that the password can be entered by voice. This, however requires software for converting voice information into text information.

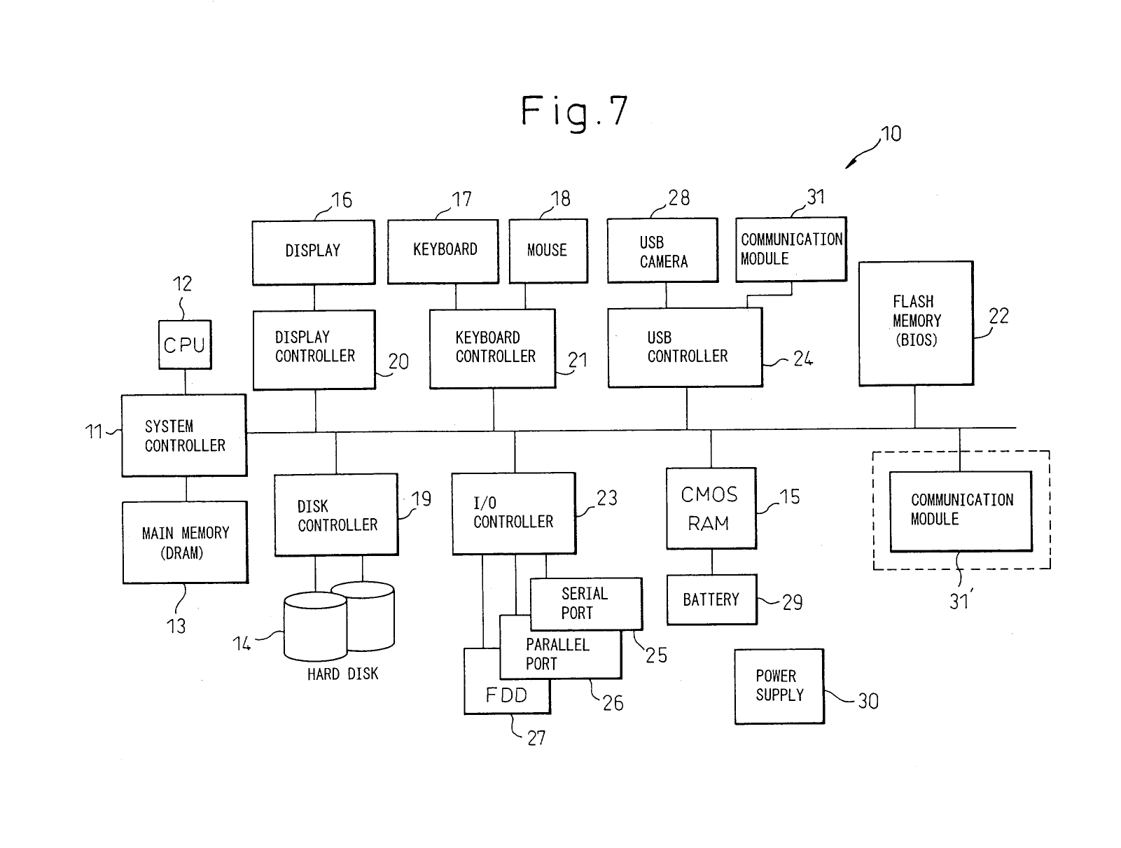

FIG. 7 is a block diagram showing, in a simplified form, the configuration of the PC 1 shown in FIG. 1. Reference numeral 11 is a system controller for controlling the operation of the various parts of the PC, 12 is a CPU, and 13 is a main memory constructed from DRAM or the like. Further, a hard disk 14 as an external storage device, a CMOS RAM 15, a display 16, a keyboard 17, a mouse 18, etc. are connected to the apparatus of this embodiment, and these devices are controlled by a disk controller 19, a display controller 20, and a keyboard controller 21, respectively.

The apparatus further includes a flash memory 22 for storing the BIOS, an I/O controller 23, and a USB controller 24; here, the I/O controller 23 controls a serial port 25, a parallel port 26, a floppy disk drive 27, etc. and the USB controller 24 controls, for example, a digital camera 28 or a printer (not shown) connected via a USB terminal. Further, in FIG. 7, reference numeral 29 indicates a battery for driving the CMOS RAM 5, and 30 designates a power supply for providing power necessary to drive the apparatus from an external power source, for example, a commercial power line.

The above configuration is only illustrative, and the invention is not limited to any particular example; further, the configuration and operation of each component are well known, and therefore, will not be described in detail here.

In one embodiment of the present invention, a Bluetooth-compatible communication module 31 is connected to the above-configured PC via the USB controller 24. The communication module 31 need not necessarily be configured as a USB-compatible external device as shown here, but may be configured so as to be connected directly to the system controller 1, as shown by dashed lines (31′). Which configuration should be employed can be selected as desired when designing the PC.

The communication module 31 (31′) is constructed using a one-chip CMOS LSI and an antenna.

In the embodiment of the present invention described above, the portable information apparatus 3 is associated with the PC 1 on a one-to-one basis but, by preregistering with the BIOS, the PC can be configured to recognize a plurality of portable information apparatuses by assigning a password to each of them. This is because usually, using Bluetooth, a plurality of devices can be connected together over a piconet. This enables one PC to be shared by a plurality of users while maintaining high security.

### ADVANTAGEOUS EFFECT OF THE INVENTION

As described above, in the security system for the information processing apparatus according to the present invention, even when power is turned on to the information processing apparatus, the display screen does not change to the password entry screen unless a user, who wears or carries with him a portable information apparatus incorporating a communication module preregistered in the BIOS, is in the vicinity of the information processing apparatus such as a PC. Accordingly, even if the portable information apparatus is stolen, the OS does not start up unless the correct password is entered. This serves to further strengthen the security.

Since an existing system such as an ordinary portable telephone or a PDA can be used as the portable information apparatus, the security system can be implemented easily and at low cost without requiring the construction of special hardware for the implementation.

The security feature can be further strengthened by making provisions so that the OS will not start up unless the password preregistered in the BIOS is entered from the designated portable information apparatus.

On the other hand, if the user leaves the information processing apparatus such as a PC with the password entered therein, the communication link between the modules is disconnected and, under this condition, the input device lock state is set. This serves to enhance the security against unauthorized use of the information processing apparatus when the apparatus is left with the password entered therein.

What is claimed is:

1. A security system for an information processing apparatus, comprising:
said information processing apparatus equipped with a first communication module having wireless data communication capability; and
a portable information apparatus equipped with a second communication module capable of forming a wireless communication link with said first communication module,
wherein said information processing apparatus is configured so as to present a password entry screen only when said communication link is formed between said first and said second communication module.

2. A security system for an information processing apparatus as claimed in claim 1, wherein said information processing apparatus starts up an OS only when entry of a preregistered password is received from said portable information apparatus.

3. A security system for an information processing apparatus as claimed in claim 1, wherein said first and second communication modules are Bluetooth-compatible communication modules.

4. A security system for an information processing apparatus as claimed in claim 2, wherein said information processing apparatus places input devices in a locked state, during startup of the OS, upon recognizing a disconnection of said communication link established between said first and second communication modules.

5. A security system for an information processing apparatus as claimed in claim 4, wherein said input devices are a keyboard and a mouse.

6. A security system for an information processing apparatus as claimed in claim 5 wherein, when a resume button is operated, said information processing apparatus presents said password entry screen only when said communication link is established between said first and second communication modules, and restores the OS when the preregistered password is entered.

7. A security system for an information processing apparatus as claimed in claim 1, comprising a plurality of said portable information apparatuses, wherein said first communication module is capable of recognizing each of said second communication modules in said plurality of portable information apparatuses.

8. A security system for an information processing apparatus as claimed in claim 7, wherein said information processing apparatus preassigns a different password to each of said second communication modules in said plurality of portable information apparatuses.

9. A security system for an information processing apparatus as claimed in claim 1, wherein said portable information apparatus is a portable telephone.

10. A security system for an information processing apparatus as claimed in claim 1, wherein said portable information apparatus is a PDA.

11. A security system for an information processing apparatus as claimed in claim 2, wherein said password can be entered in the form of voice via said portable information apparatus.

12. An information processing apparatus, comprising a communication module having wireless data communication capability, wherein said apparatus is configured so as to present a password entry screen when said communication module has set up a communication link with an external wireless communication module.
